(19) United States
(12) Patent Application Publication
(10) Pub. No.: US 2008/0162639 A1
(43) Pub. Date: Jul. 3, 2008

(54) System and method for identifying peer-to-peer (P2P) application service

(75) Inventors: Dae Hee Kang, Yusung-gu (KR); Young Tae Han, Yusung-gu (KR); Hong Sik Park, Yusung-gu (KR); Yeong Ro Lee, Yongin-shi (KR); Sang Yong Ha, Seodaemun-gu (KR); Chin Chul Kim, Eunpyung-gu (KR); Yong Hyun Jo, Gangdong-gu (KR); Ji Yeon Yu, Seongbuk-gu (KR)

Correspondence Address: THE WEBB LAW FIRM, P.C., 700 KOPPERS BUILDING, 436 SEVENTH AVENUE, PITTSBURGH, PA, 15219, US

(73) Assignee: Research and Industrial Cooperation Group, Yuseong-Gu (KR)

(21) Appl. No.: 11/789,404

(22) Filed: Apr. 24, 2007

(30) Foreign Application Priority Data
Dec. 28, 2006 (KR) 10-2006-0135834

(51) Int. Cl. G06F 15/16

(52) U.S. Cl. 709/205

(57) ABSTRACT

Provided are a system and method for identifying a peer-to-peer (P2P) application service. The method includes the steps of: (a) collecting an Internet protocol (IP) packet and generating a flow; (b) identifying the P2P application service on the basis of a port number using the generated flow; (c) when the P2P application service is identified in step (b), verifying the identified application service; (d) when it is verified that the identification is not correct, or the P2P application service is not identified in step (b), identifying the P2P application service on the basis of a payload; (e) when the P2P application service is identified in step (d) or it is verified in step (c) that the identification is correct, generating a SET table using a flow of the identified P2P application service; and (f) identifying the P2P application service for a flow not identified in either step (b) or step (d) using the SET table.

### BACKGROUND OF THE INVENTION

1. Field of the Invention

The present invention relates to a system and method for identifying a peer-to-peer (P2P) application service by collecting and analyzing traffic, and more particularly, to a system and method for identifying a P2P application service using various identification methods through several stages rather than one identification method in traffic analysis.

2. Discussion of Related Art

Recently, as Internet use drastically increases all over the world, and network-based application programs are variously developed and used, network traffic is abruptly increasing. This is because many services and application programs, such as unification of voice networks, new streaming, P2P file sharing, games, etc., as well as traditional Internet application programs, such as world wide web (WWW), file transfer protocol (FTP), e-mail, etc., are operated on the basis of the Internet.

In order to support the increasing traffic, Internet service providers (ISPs) are continuously extending the network. However, it is not yet possible to obtain accurate information on how much and what kind of traffic is generated by whom because conventional text or image-centered traffic is being changed into streaming media and P2P-centered traffic.

A P2P system has an application program structure in which respective users (peers) are service providers for each other while performing functions requested by other users using the services. In other words, a peer simultaneously serves as a server and a client, and thus data is bidirectionally transferred. As for data flow, in a client/server structure, most data is transferred from a server to a client. On the other hand, in a P2P structure, data is liberally exchanged between peers, and thus traffic is neither concentrated to one peer nor forwarded in just one direction. Network application programs that are currently recognized as P2P application programs can be roughly classified into two kinds: a messenger application program, and a file sharing application program.

In the current network, traffic of P2P application services occupies most of bandwidth. In order to manage such traffic, most network administrators use a port number of a specific application service or compare payload information through protocol-based analysis, thereby detecting the specific application service.

First, a method using a port number checks only the port number of a transport layer in a received packet, thereby identifying traffic. For example, a port number for accessing Internet home pages is 80, port numbers for downloading files using FTP are 20 and 21, and port numbers for receiving movie packet data are 554 and 1755. Since most packets are sent and received through previously set ports, the port number of the transport layer is obtained to analyze application of packets. However, since P2P application services are provided using arbitrary port numbers or the port numbers of other application services so as to conceal traffic thereof, efficient analysis is difficult.

Next, a method that analyzes traffic by comparing payload information of collected packets analyzes the payload of a control session packet so as to find out the data transfer port of a multimedia service. Such a payload-based analysis method is relatively accurate but has a drawback in that the amount of data to be processed overloads a system with the increased link speed.

Since quality assurance according to application services is necessary for a next generation network, a method of more quickly and correctly identifying a P2P service from traffic is in demand.

### SUMMARY OF THE INVENTION

The present invention is directed to a system and method for identifying a peer-to-peer (P2P) application service, capable of quickly and accurately analyzing a flow modified by a user's intention and identifying the P2P application service.

One aspect of the present invention provides a system for identifying a P2P application service, comprising: a flow generation unit for collecting an Internet protocol (IP) packet and generating a flow; a port number-based identification unit for identifying a P2P application service on the basis of a port number using the flow generated by the flow generation unit; a verification unit for verifying the P2P application service identified by the port number-based identification unit; a payload-based identification unit for, when the verification unit determines that the identification performed by the port number-based identification unit is not correct, or the P2P application service is not identified by the port number-based identification unit, identifying the P2P application service on the basis of a payload; a SET table generation unit for, when the P2P application service is identified by the payload-based identification unit, or the verification unit determines that the identification performed by the port number-based identification unit is correct, generating a SET table using a flow of the identified P2P application service; and a SET table-based identification unit for identifying the P2P application service for a flow not identified by either the port number-based identification unit or the payload-based identification unit using the SET table generated by the SET table generation unit.

Here, the flow generation unit may generate the flow by combining a transmitter IP, a transmitter port, a receiver IP, a receiver port, and a protocol of the collected IP packet. In addition, the verification unit may perform verification using payload information or service ports of a transmitting end and a receiving end.

Another aspect of the present invention provides a method of identifying a P2P application service, comprising the steps of: (a) collecting an Internet protocol (IP) packet and generating a flow; (b) identifying the P2P application service on the basis of a port number using the generated flow; (c) when the P2P application service is identified in step (b), verifying the identified application service; (d) when it is verified that the identification is not correct, or the P2P application service is not identified in step (b), identifying the P2P application service on the basis of a payload; (e) when the P2P application service is identified in step (d) or it is verified in step (c) that the identification is correct, generating a SET table using a flow of the identified P2P application service; and (f) identifying the P2P application service for a flow not identified in either step (b) or step (d) using the SET table.

Here, in step (a), the flow may be generated by combining a transmitter IP, a transmitter port, a receiver IP, a receiver port, and a protocol of the collected IP packet. In addition, in step (c), the verification may be performed using payload information or service ports of a transmitting end and a receiving end.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a system for identifying a peep-to-peer (P2P) application service according to an exemplary embodiment of the present invention;

FIG. 2 is a flowchart illustrating an identification method performed in the system for identifying a P2P application service shown in FIG. 1;

FIG. 3 is a diagram illustrating generation and use of SET tables; and

FIG. 4 illustrates an example of identifying modified P2P application services using a system and method for identifying a P2P application service according to the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

### Exemplary Embodiment

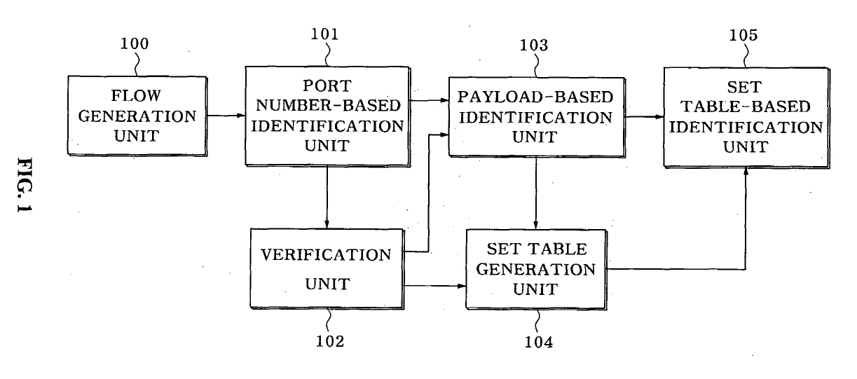

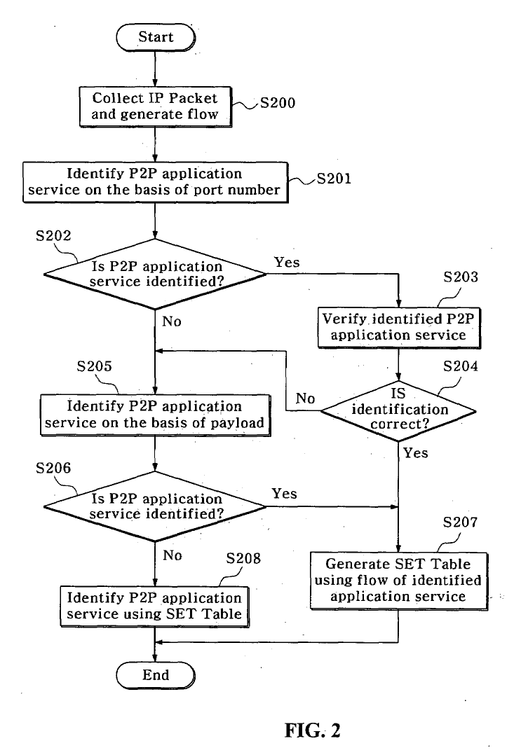

FIG. 1 is a block diagram of a system for identifying a peep-to-peer (P2P) application service according to an exemplary embodiment of the present invention, and FIG. 2 is a flowchart illustrating an identification method performed in the system for identifying a P2P application service shown in FIG. 1.

Referring to FIGS. 1 and 2, first, a flow generation unit 100 collects an Internet protocol (IP) packet and generates a flow (step 200). The flow may be made of a combination of a transmitter IP, a transmitter port, a receiver IP, a receiver port, and a protocol.

Subsequently, a port number-based identification unit 101 identifies a P2P application service on the basis of a port number using the flow generated by the flow generation unit 100 (step 201). The port number-based identification unit 101 checks well-known transmitting and receiving ports in flow information to thereby identify a P2P application service. For example, it can be determined that a hypertext transport protocol (HTTP) service is used when port 80 is used, and a file transfer protocol (FTP) service is used when port 21 is used.

When a P2P application service is identified on the basis of the port number (step 202), a verification unit 102 verifies the identified application service (step 203). This is because although the identification based on the port number of step 201 can be quickly performed, it may be incorrect due to the determination based on the port number alone.

The verification unit 102 may perform the verification using payload information of the P2P application service. By such verification, it is possible to obtain the accuracy of a payload method while reducing system load.

In addition, the verification unit 102 may verify an application service having no payload information using the relationship between service ports of a transmitting end and a receiving end. Since the transmitting end can randomly change and use its application service port but cannot change the counterpart's port number, the verification is performed using the port numbers of both the transmitting and receiving ends. For example, in case of a game service such as Starcraft, both the transmitting and receiving ends use port 6112 to provide the service.

When it is determined as a result of the verification that the identification is not correct (step 204), or the P2P application service is not identified on the basis of the port number in step 202, a payload-based identification unit 103 identifies the P2P application service on the basis of a payload (step 205). In other words, with respect to flows that are neither identified on the basis of the port number nor determined to be incorrect in the verification process of identification, the identification based on payloads is performed by checking the payloads of protocols to identify the P2P application service.

For example, in a case of Microsoft Network (MSN) messenger service, a payload includes PNG (code for checking ping), USR (code for checking a user), MSG (message transfer), JOI (new user joining), and so on.

In general, the operation of checking payloads involves processing a large amount of data. However, in the present invention, since a number of application services are already identified through identification based on the port number, the amount of data to be processed in the identification process based on payloads is considerably reduced.

When the P2P application service is identified on the basis of the payload, or the identification is verified in step 204, a SET table generation unit 104 generates a SET table using the flow of the identified P2P application service (step 207).

Subsequently, with respect to flows that are not identified by either the port number-based identification or the payload-based identification, a SET table-based identification unit 105 identifies the P2P application service using the SET table (step 208). The P2P application services can be identified by the port number-based identification and the payload-based identification, but such traffic may not be detected by the port number-based identification and the payload-based identification because many P2P users intentionally modify and use traffic so as to conceal the traffic. In order to detect such modified traffic, the SET table-based identification method is used.

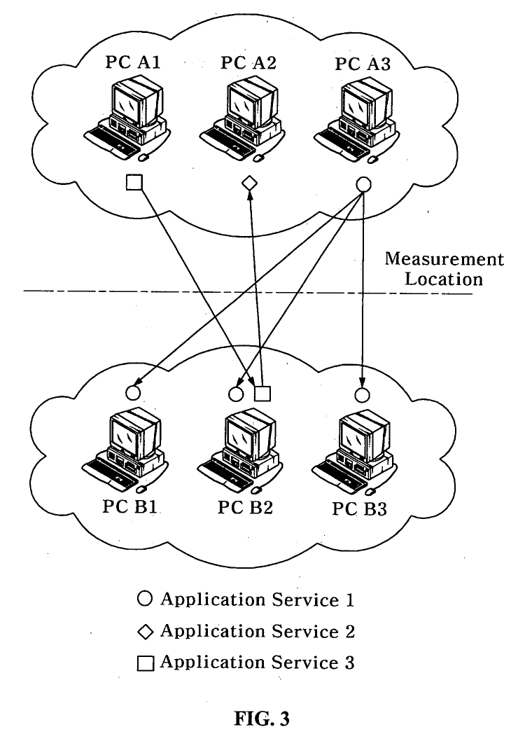

Generation and use of SET tables will now be described with reference to FIG. 3. All flows connected to one IP and one port are referred to as one SET, and one SET includes all flows generated by the same application service. Here, application services exchanging packets with each other are identified as the same application service. Therefore, in FIG. 3, application service 2 and application service 3 have different flow information but may be identified as the same application service by connection of flows.

For example, SET tables made in FIG. 3 are as follows.

SET A={A1.3 (application service number), A2.2, B2.3}

SET B={A3.1, B1.1, B2.1, B3.1}

All application services in SET A are the same application service, and a service communicating with the application service may be considered as the same application service. More specifically, after generating a SET, when a specific unidentified flow corresponds to a value in the SET, the specific flow can be identified.

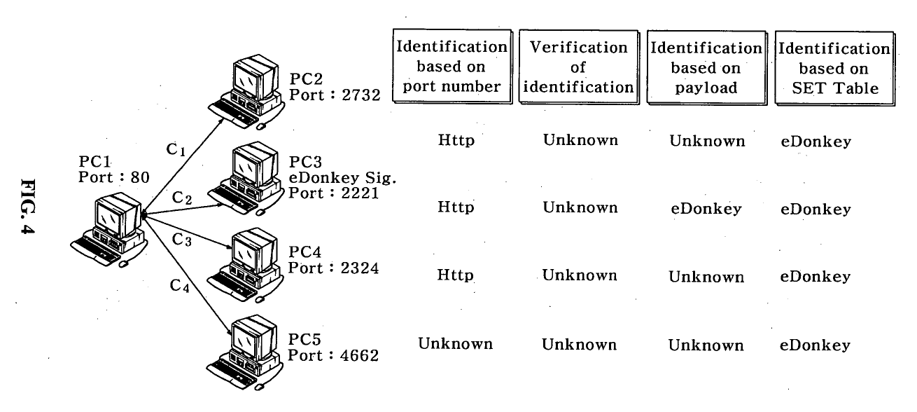

FIG. 4 illustrates an example of identifying modified P2P application services using a system and method for identifying a P2P application service according to the present invention.

As illustrated in FIG. 4, PC2, PC3, PC4 and PC5 exchange packets with PC1 that uses a modified port. A flow between PC1 and PC2 is referred to as C1, a flow between PC1 and PC3 is referred to as C2, a flow between PC1 and PC4 is referred to as C3, and a flow between PC1 and PC5 is referred to as C4.

Among the four flows, a P2P application service was not identified from C4 by either port number-based identification or payload-based identification. C1 and C3 were identified as modified flows by port number-based identification. And, C2 was identified as a P2P application service flow in a payload-based identification process. Consequently, it is possible to identify C1, C2, C3 and C4 all by SET table-based identification as described above.

As described above, according to the present invention, conventional problems are solved, and simultaneously, a P2P application service can be quickly and correctly identified by multi-stage flow analysis.

In addition, since protocols of all flows are not checked, the amount of data to be processed is reduced, thereby enabling quick identification. Also, it is possible to detect a flow modified by a user's intention through SET-table-based identification.

Consequently, it is possible to safely and efficiently operate a network by detecting abnormal traffic, such as a Worm virus, in network administration.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system for identifying a peer-to-peer (P2P) application service, comprising:
a flow generation unit for collecting an Internet protocol (IP) packet and generating a flow;
a port number-based identification unit for identifying a P2P application service on the basis of a port number using the flow generated by the flow generation unit;
a verification unit for verifying the P2P application service identified by the port number-based identification unit;
a payload-based identification unit for, when the verification unit determines that the identification performed by the port number-based identification unit is not correct, or the P2P application service is not identified by the port number-based identification unit, identifying the P2P application service on the basis of a payload;
a SET table generation unit for, when the P2P application service is identified by the payload-based identification unit, or the verification unit determines that the identification performed by the port number-based identification unit is correct, generating a SET table using a flow of the identified P2P application service; and
a SET table-based identification unit for identifying the P2P application service for a flow not identified by either the port number-based identification unit or the payload-based identification unit using the SET table generated by the SET table generation unit.

2. The system of claim 1, wherein the flow generation unit generates the flow by combining a transmitter IP, a transmitter port, a receiver IP, a receiver port, and a protocol of the collected IP packet.

3. The system of claim 1, wherein the verification unit performs verification using payload information.

4. The system of claim 1, wherein the verification unit performs verification using service ports of a transmitting end and a receiving end.

5. A method of identifying a peer-to-peer (P2P) application service, comprising the steps of:
(a) collecting an Internet protocol (IP) packet and generating a flow;
(b) identifying the P2P application service on the basis of a port number using the generated flow;
(c) when the P2P application service is identified in step (b), verifying the identified application service;
(d) when it is verified that the identification is not correct, or the P2P application service is not identified in step (b), identifying the P2P application service on the basis of a payload;
(e) when the P2P application service is identified in step (d) or it is verified in step (c) that the identification is correct, generating a SET table using a flow of the identified P2P application service; and
(f) identifying the P2P application service for a flow not identified in either step (b) or step (d) using the SET table.

6. The method of claim 5, wherein, in step (a), the flow is generated by combining a transmitter IP, a transmitter port, a receiver IP, a receiver port, and a protocol of the collected IP packet.

7. The method of claim 5, wherein, in step (c), the verification is performed using payload information.

8. The method of claim 5, wherein, in step (c), the verification is performed using service port of a transmitting end and a receiving end.

9. A recording medium storing the method of any one of claims 5 to 8 using computer-executable program code.
